(19) United States
(12) Patent Application Publication
(10) Pub. No.: US 2022/0376803 A1
(43) Pub. Date: Nov. 24, 2022

(54) Electromagnetic Propagation Modeling Calibration through Crowd-Sourced and Secondary Measurements

(71) Applicant: Google LLC, Mountain View, CA (US)

(72) Inventor: Preston Marshall, Woodbridge, VA (US)

(73) Assignee: Google LLC, Mountain View, CA (US)

(21) Appl. No.: 17/663,259

(22) Filed: May 13, 2022

Related U.S. Application Data
(60) Provisional application No. 63/190,648, filed on May 19, 2021.

(51) Int. Cl. H04B 17/391; H04B 17/318

(52) U.S. Cl. CPC H04B 17/391; H04B 17/318

(57) ABSTRACT

A method includes requesting, from a plurality of mobile devices, electromagnetic (EM) path loss data characterizing EM loss between two different geographical points. For each mobile device, the method includes receiving, from the respective mobile device, a first EM signal strength value characterizing EM loss between a first geographical point and a second geographical point. The method also includes receiving, from the respective mobile device, a second EM signal strength value characterizing EM loss between the first geographical point and a third geographical point. The method also includes determining a respective relative path loss between the second geographical point and the third geographical point using the first and second EM signal strength values. The method also includes generating, using the respective relative path loss of each mobile device, an EM propagation model for a geographical area that encompasses the first and second geographical points.

### CROSS REFERENCE TO RELATED APPLICATIONS

This U.S. patent application claims priority under 35 U.S.C. § 119(e) to U.S. Provisional Application 63/109,648, filed on May 19, 2021. The disclosure of this prior application is considered part of the disclosure of this application and is hereby incorporated by reference in its entirety.

### TECHNICAL FIELD

This disclosure relates to electromagnetic propagation modeling calibration through crowd-sourced and secondary measurements.

### BACKGROUND

Accurate electromagnetic propagation modeling is becoming increasingly critical to both maximize effective use of scarce spectrum resources and to manage the deployment of wireless systems. Accurate electromagnetic propagation modeling typically requires very detailed data representations of terrain, structures, vegetation, and other impediments to electromagnetic signal energy. Thus, performing propagation modeling requires a large corpus of data that is both expensive and disruptive to obtain.

### SUMMARY

One aspect of the disclosure provides a computer-implemented method providing electromagnetic propagation modeling calibration through crowd-sourced and secondary measurements. The method, when executed by data processing hardware, causes the data processing hardware to perform operations. The operations include requesting, from a plurality of mobile devices, electromagnetic (EM) path loss data characterizing EM loss between two different geographical points For each respective mobile device in the plurality of mobile devices, the operations include receiving, from the respective mobile device, a first EM signal strength value characterizing EM loss between a corresponding first geographical point and a corresponding second geographical point. The corresponding first and second geographical points corresponding to the respective mobile device are different than the corresponding first and second geographical points corresponding to each other mobile device in the plurality of mobile devices. The operations also include receiving, from the respective mobile device, a second EM signal strength value characterizing EM loss between the corresponding first geographical point and a corresponding third geographical point The corresponding third geographical point corresponding to the respective mobile device is different than the corresponding third geographical point corresponding to each other mobile device in the plurality of mobile devices. The operations also include determining a respective relative path loss between the corresponding second geographical point and the corresponding third geographical point using the first EM signal strength value and the second EM signal strength value and generating, using the respective relative path loss determined for each mobile device of the plurality of mobile devices, an EM propagation model for a geographical area that encompasses the different first and second geographical points corresponding to the plurality of mobile devices.

Implementations of the disclosure may include one or more of the following optional features. In some implementations, determining the respective relative path loss between the corresponding second geographical point and the corresponding third geographical point includes estimating a first free space component of the EM loss between the corresponding first geographical point and the corresponding second geographical point, determining a first non-free space component of the EM loss between the corresponding first geographical point and the corresponding second geographical point using the estimated first free space component, and estimating a second free space component of the EM loss between the corresponding first geographical point and the corresponding third geographical point. Determining the respective relative path loss between the corresponding second geographical point and the corresponding third geographical point may also include determining a second non-free space component of the EM loss between the corresponding first geographical point and the corresponding third geographical point using the estimated second free space component and determining the respective relative path loss between the corresponding second geographical point and the corresponding third geographical point using the determined first non-free space component and the determined second non-free space component. In some of these implementations, determining the respective relative path loss between the corresponding second geographical point and the corresponding third geographical point is based on a difference between the first non-free space component and the second non-free space component.

In some examples, one or more of the plurality of mobile devices includes a smart phone. The first EM signal strength value and the second EM signal strength value each represent a corresponding signal strength value level above a reference value. The first EM signal strength value, in some implementations, indicates a strength of a signal received from a cellular base station Optionally, for each respective mobile device in the plurality of mobile devices, the operations further include receiving, from the respective mobile device, a third EM signal strength value characterizing EM loss between the corresponding first geographical point and the corresponding second geographical point and discarding the third EM signal strength value. In these examples, the first EM signal strength value is greater than the third EM signal strength value.

In some implementations, for each respective mobile device in the plurality of mobile devices, the operations further include, prior to determining the respective relative path loss between the corresponding second geographical point and the corresponding third geographical point, determining that both the first EM signal strength value and the second EM signal strength value satisfy a minimum EM signal strength value. For one of the respective mobile devices of the plurality of mobile devices, the corresponding first geographical point may include a location within a first floor of a building and the corresponding second geographical point may include a location within a second floor of the building. In some implementations, for each respective mobile device in the plurality of mobile devices, the operations further include receiving, from the respective mobile device, a third EM signal strength value characterizing EM loss between the corresponding first geographical point and a corresponding fourth geographical point and determining a relative path loss between the corresponding third geographical point and the corresponding fourth geographical point using the second EM signal strength value and the third EM signal strength value.

Another aspect of the disclosure provides a system for providing electromagnetic propagation modeling calibration through crowd-sourced and secondary measurements. The system indades data processing hardware and memory hardware in communication with the data processing hardware. The memory hardware stores instructions that when executed on the data processing hardware cause the data processing hardware to perform operations. The operations include requesting, from a plurality of mobile devices, electromagnetic (EM) path loss data characterizing EM loss between two different geographical points. For each respective mobile device in the plurality of mobile devices, the operations include receiving, front the respective mobile device, a first EM signal strength value characterizing EM loss between a corresponding first geographical point and a corresponding second geographical point. The corresponding first and second geographical points corresponding to the respective mobile device are different than the corresponding first and second geographical points corresponding to each other mobile device in the plurality of mobile devices. The operations also include receiving, from the respective mobile device, a second EM signal strength value characterizing EM loss between the corresponding first geographical point and a corresponding third geographical point. The corresponding third geographical point corresponding to the respective mobile device is different than the corresponding third geographical point corresponding to each other mobile device in the plurality of mobile devices. The operations also include determining a respective relative path loss between the corresponding second geographical point and the corresponding third geographical point using the first EM signal strength value and the second EM signal strength value and generating, using the respective relative path loss determined for each mobile device of the plurality of mobile devices, an EM propagation model for a geographical area that encompasses the different first and second geographical points corresponding to the plurality of mobile devices

This aspect may include one or more of the following optional features. In some implementations, determining the respective relative path loss between the corresponding second geographical point and the corresponding third geographical point includes estimating a first free space component of the EM loss between the corresponding first geographical point and the corresponding second geographical point, determining a first non-free space component of the EM loss between the corresponding first geographical point and the corresponding second geographical point using the estimated first free space component, and estimating a second free space component of the EM loss between the corresponding first geographical point and the corresponding third geographical point. Determining the respecti ve relative path loss between the corresponding second geographical point and the corresponding third geographical point may also include determining a second non-free space component of the EM loss between the corresponding first geographical point and the corresponding third geographical point using the estimated second free space component and determining the respective relative path loss between the corresponding second geographical point and the corresponding third geographical point using the determined first non-free space component and the determined second non-free space component. In some of these implementations, determining the respective relative path loss between the corresponding second geographical point and the corresponding third geographical point is based on a difference between the first non-free space component and the second non-free space component.

In some examples, one or more of the plurality of mobile devices includes a smart phone. The first EM signal strength value and the second EM signal strength value each represent a corresponding signal strength value level above a reference value. The first EM signal strength value, in some implementations, indicates a strength of a signal recei ved from a cellular base station. Optionally, for each respective mobile device in the plurality of mobile devices, the operations further include receiving, from the respective mobile device, a third EM signal strength value characterizing EM loss between the corresponding first geographical point and the corresponding second geographical point and discarding the third EM signal strength value. In these examples, the first EM signal strength value is greater than the third EM signal strength value

In some implementations, for each respective mobile device in the plurality of mobile devices, the operations further include, prior to determining the respective relative path loss between the corresponding second geographical point and the corresponding third geographical point, determining that both the first EM signal strength value and the second EM signal strength value satisfy a minimum EM signal strength value. For one of the respective mobile devices of the plurality of mobile devices, the corresponding first geographical point may include a location within a first floor of a building and the corresponding second geographical point may include a location within a second floor of the building. In some implementations, for each respective mobile device in the plurality of mobile devices, the operations further include receiving, from the respective mobile device, a third EM signal strength value characterizing EM loss between the corresponding first geographical point and a corresponding fourth geographical point and determining a relative path loss between the corresponding third geographical point and the corresponding fourth geographical point using the second EM signal strength value and the third EM signal strength value.

The details of one or more implementations of the disclosure are set forth in the accompanying drawings and the description below. Other aspects, features, and advantages will be apparent from the description and drawings, and from the claims

### DESCRIPTION OF DRAWINGS

FIG. 1 is a schematic view of a system for providing electromagnetic propagation modeling calibration through crowd-sourced and secondary measurements

FIG. 2 is a schematic view of a loss controller receiving multiple signal strength values from a mobile device.

FIG. 3 is a schematic view of a sequence of signal strength values tracking a path of the mobile device of FIG. 2.

FIG. 4 is a schematic view of a relative loss between subsequent signal strength values.

FIG. 5 is a schematic view of an exemplary electromagnetic propagation model fora geographical area.

FIG. 6 is a flowchart of an example arrangement of operations for a method of providing electromagnetic propagation modeling calibration through crowd-sourced and secondary measurements.

PIG. 7 is a schematic view of an example computing device that may be used to implement the systems and methods described herein.

Like reference symbols in the various drawings indicate like elements.

DETAILED DESCRIPTION

Accurate electromagnetic (EM) propagation modeling is critical to maximizing effective use of scarce spectrum resources and managing deployment of wireless systems (e.g., planning networks, predicting interference, and resolving service issues). However, multiple fundamental challenges plague the development of these propagation models. Primarily, these challenges arise from a lack of a large corpus of measurements to develop and calibrate models and the inability to tailor models to the characteristics that are unique to specific buildings and structures.

Conventional propagation models, and the process for developing them, suffer from a variety of drawbacks. For example, the data required to develop and calibrate propagation models is expensive and disruptive to obtain. Therefore, many propagation models in use today are not based on actual measurements, but instead are extrapolations of a limited number of measurements. These measurements are often at more than an octave or more difference in frequency in a limited (if any) set of attenuative environments. Moreover, the data typically includes only a relatively small number of data points that must be extrapolated in order to attempt to reflect a vast number of cases and situations.

To properly predict and address the wide range of conditions, frequencies, and locations necessary for deploying and supporting wireless network, the data to develop, train, and calibrate propagation models must be robust, plentiful, and reflective of the actual frequencies contemplated for use while also being inexpensive to obtain. Additionally, conventional propagation models are generic and tend to oversimplify complex situations rather than be specific to individual buildings, structures, and locations For example, indoor/outdoor path loss is highly critical for a number of applications such as network planning and spectrum sharing, but generalized assumptions of indoor/outdoor path loss are almost all radically incorrect, as these values can vary from less than 1 dB to 50 dB or even greater than 100 dB. However, these variations are not reflected in current propagation models. As an example, a general propagation model cannot differentiate between a commercial or multi-dwelling unit with conventional six inch thick rebar concrete slab floors and the same general building with tensioned, pre-stressed concrete with only three inches of slab thickness. Yet this small (and not readily visible) engineering design difference may account for a reduction of inter-floor path loss of from 52 dB to 26 dB (respectively) and radically impact the ability to provide services between floors or to share spectrum between them. As the use of propagation models increasingly focuses on higher frequencies (e.g., 5G systems) and dense, urban capacity networks, typical methods of treating all buildings as if they are the same is increasingly inadequate. While such methods may be acceptable in some lower frequency coverage networks, they are wholly unsatisfactory for higher frequency capacity networks that are dominating the landscape today and in the future.

Implementations herein provide an EM loss controller that provides EM propagation modeling using crowd-sourced and secondary measurements. The loss controller provides additional uses for data collected collaterally for other purposes. The loss controller generates models that may be tailored to specific or individual structures and locations such that very detailed and precise predictions of the electromagnetic characteristics can be determined. The loss controller obtains loss data on a wide range of locations and bands of interest and associates this data with the geo-spatial characteristics of these locations on a highly granular scale

Crowd-sourcing data provides an attractive answer to obtaining a large corpus of data as it can be widely available and in high quantities. However, the use of crowd-sourced propagation path loss data has a number of challenges. Tor example, lack of calibration and unknown performance characteristics of the devices providing the measurements require compensation. Manufacturers generally do not calibrate the analog components of many of common devices to a high level of accuracy, and unit-to-unit variations during production may be relatively significant compared to laboratory standard test arid measurement equipment. Thus, crowd-sourced measurements, using conventional techniques, would not provide highly accurate measurements to facilitate the creation of conventional EM propagation models.

However, the system herein exploits traits of these devices to remedy these inherent defects of crowd-sourced data to create equivalent propagation models that are not negatively impacted by the inherent weakness of the devices. Moreover, the system addresses the case where the actual characteristics of the emitter (i.e., the source of the signal measured by the crowd-sourcing devices) is unknown in terms of exact location, power, antenna characteristics and/or other aspects that are essential to creating a simple path loss model from the emitter to the crowd-sourced receiver. The loss controller provides mechanisms to utilize crowd-sourced measurements independently of knowledge of exact source emitter characteristics.

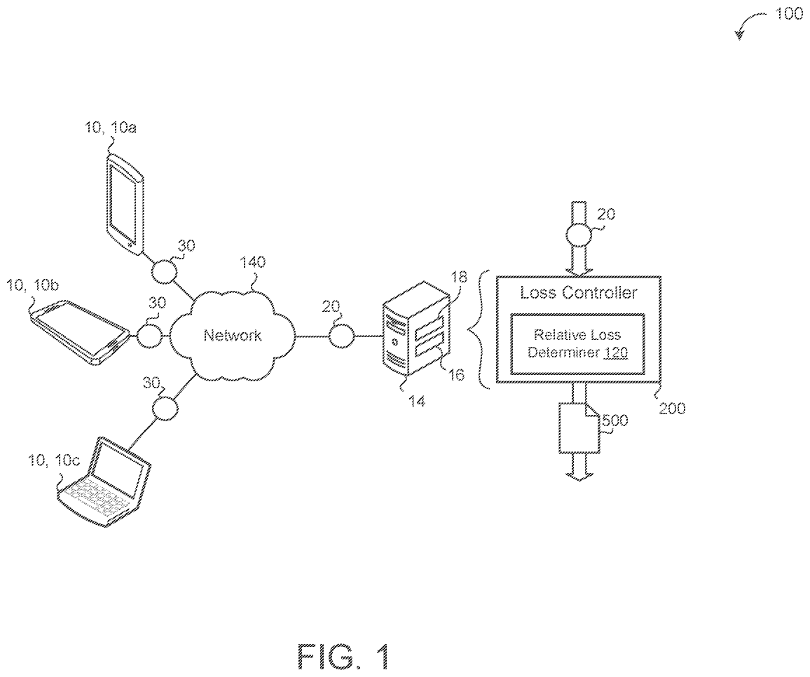

Referring io FIG. 1, in some implementations, an example system 100 includes a processing system 14 in communication with plurality of mobile devices 10, 10a-c via a network 140. The processing system 14 may be a single computer, multiple computers, or a distributed system (e.g., a cloud environment) having scalable/elastic computing resources 16 (e.g , data processing hardware) and/or storage resources 18 (e.g., memory hardware). The processing system 14 executes an electromagnetic (EM) loss controller 200.

The loss controller 200 sends a loss request 20 to each mobile device 10 that requests EM path loss data that characterizes EM loss between two different geographical points. The mobile devices 10 may correspond to any type of consumer or enterprise devices such as cell phones, tablets, laptops, and dedicated EM loss measuring equipment. As used herein, the term mobile device may be used interchangeably with the term measuring device. From each of the mobile devices 10, the loss controller 200 receives EM signal strength values 30. The term “EM signal strength value” does not necessarily imply any knowledge of the source of the signal. Instead, as used herein, EM signal strength value describes any value determined or measured by the measuring device 10 that describes a quality or strength of the received signal. For example, the value can be based on or equivalent to a signal strength value level (or some derivative thereof) measured above a reference level by the measuring device 10.

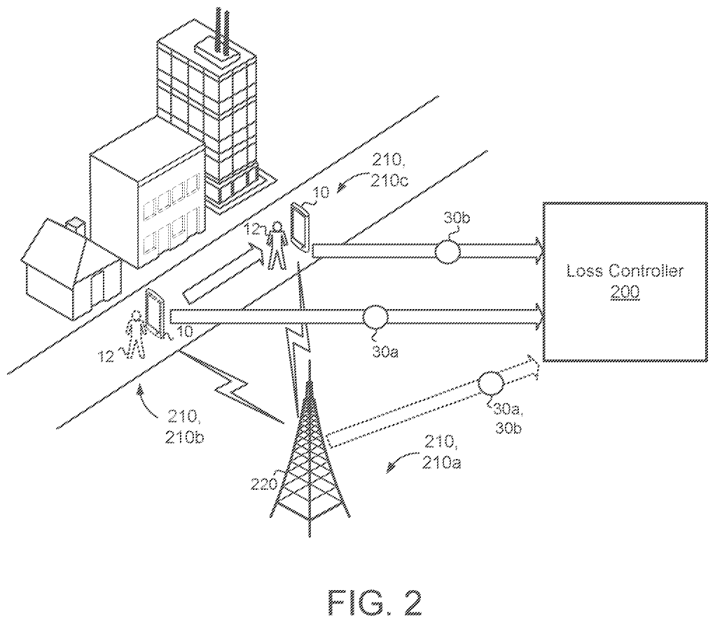

Referring now to FIG. 2, in some examples, the EM signal strength values 30 include a first EM signal strength value 30a characterizing EM loss between a corresponding first geographical point 210, 210a (also referred to herein as geographical locations 210) and a corresponding second geographical point 210b. A schematic view of the loss controller 200 shows a user 12 in possession of a mobile device 10 (a smart phone in this example) walking along a street in front of various buildings. The mobile device 10 or measuring device 10 is in wireless communication with another device which, in this example, is a cellular base tower 220. As the devices 10, 220 communicate, the communications experience loss or attenuation from features within the geographical area between the devices 10, 220. For example, the communications experience EM attenuation losses due to terrain impediments and/or non-terrain impediments. Terrain impediments include fixed terrain features that cause EM attenuation such as mountains, hills, etc Non-terrain impediments include vegetative or man-made impediments such as buildings and other structures.

During communications, either the mobile device 10 or the base tower 220 determines the first EM signal strength value 30a.Each EM signal strength value 30 characterizes the EM loss between the mobile device 10 and the base tower 220 for any other device the mobile device 10 is in communication with). That, is, each EM signal strength value 30 is associated with a specific geographical location 210, 210a-n. Particularly, the first EM signal strength value 30a characterizes the EM loss between a first geographical point 210a where the cellular base tower 220 is located and a second geographical point 210b where the mobile device 10 is located when the EM signal strength value 30a is captured Examples herein show the mobile device 10 communication with the cellular base tower 220, which are typically fixed in location, however the mobile device 10 may communicate with any other device as long as the EM signal strength values 30 are captured.

In some examples, the mobile device 10 includes one or more sensors to determine or approximate or estimate the geographical location 210 of the mobile device 10. For example, the mobile device 10 includes a GPS sensor, a Wi-Fi positioning system, or any other geolocation system to associate each EM signal strength value 30 with a specific geographical location 210. Each EM signal strength value 30 may include the geolocation information. In some examples, the mobile device 10 transmits the EM signal strength values 30 to the loss controller 200 (or to a remote server in communication with the loss controller 200) In other examples, the other device (e.g., the emitter or the cellular base tower 220) communicates the EM signal strength values 30 to the loss controller 200.

The loss controller 200 receives, from the mobile device 10, a second EM signal strength value 30b characterizing EM loss between the corresponding first geographical point 210a and a corresponding third geographical point 210c. In this example, the user 12 has traveled further down the street to the geographical point 210c or location, while still In wireless communication with the same cellular base tower 220. The mobile device 10 and/or the base tower 220 captures the second EM signal strength value 30b. Notably, the first EM signal strength value 30a and the second EM signal strength value 30b both characterize the EM loss for the mobile device 10 from the same geographical point 210a of the cellular base tower 220. That is, tire first geographical location 210a of the first EM signal strength value 30a and the second EM signal strength value 30b are the same while the second geographical point 210b and the third geographical point 210c are different fin this example, from the user 12 moving the mobile device 10).

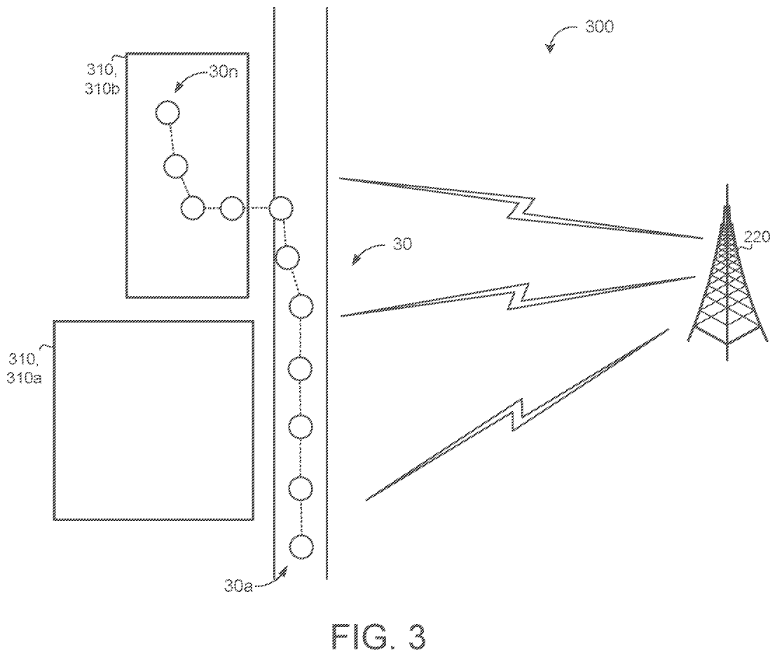

Referring now to FIG. 3, as the mobile device 10 moves around a geographical area 300 while in wireless communication with a remote device (e.g., the base tower 220), the mobile device 10 and/or the base tower 220 intermittently or periodically determines EM signal strength values 30. Here, the mobile device 10 is carried along a sidewalk in front of a first building 310,310a and captures a series of EM signal strength values 30, 30a-n beginning with an initial first EM signal strength, value 30a. The EM signal strength values 30 are akin to a series of waypoints that track the EM loss for communications between the mobile device 10 and the base tower 220 at various geographical points 210. In this example, after passing the first building 310a, the mobile device 10 is carried into a second building 310, 310b where a final EM signal strength value 30n is captured or determined.

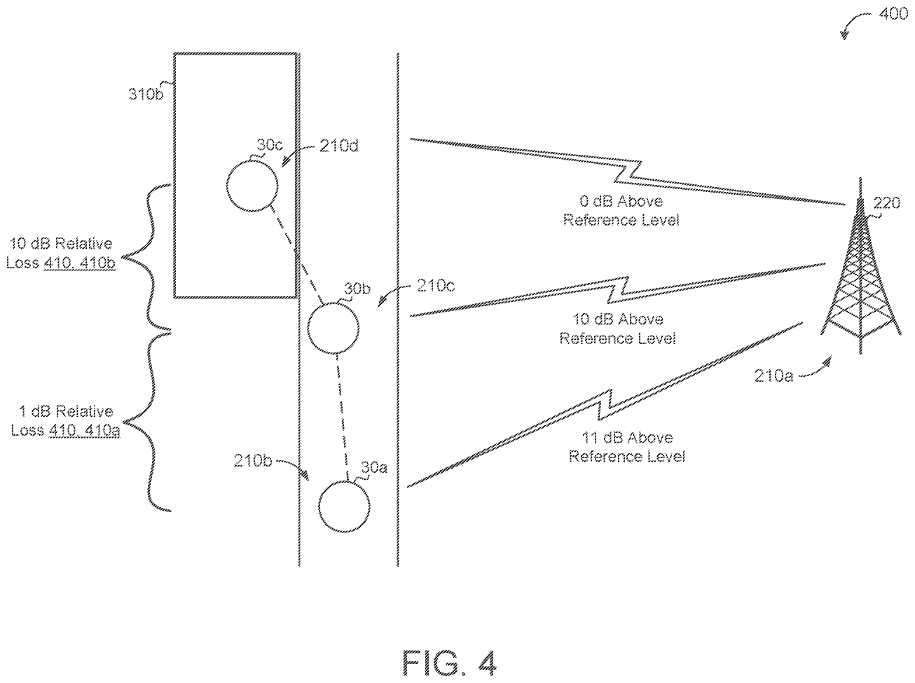

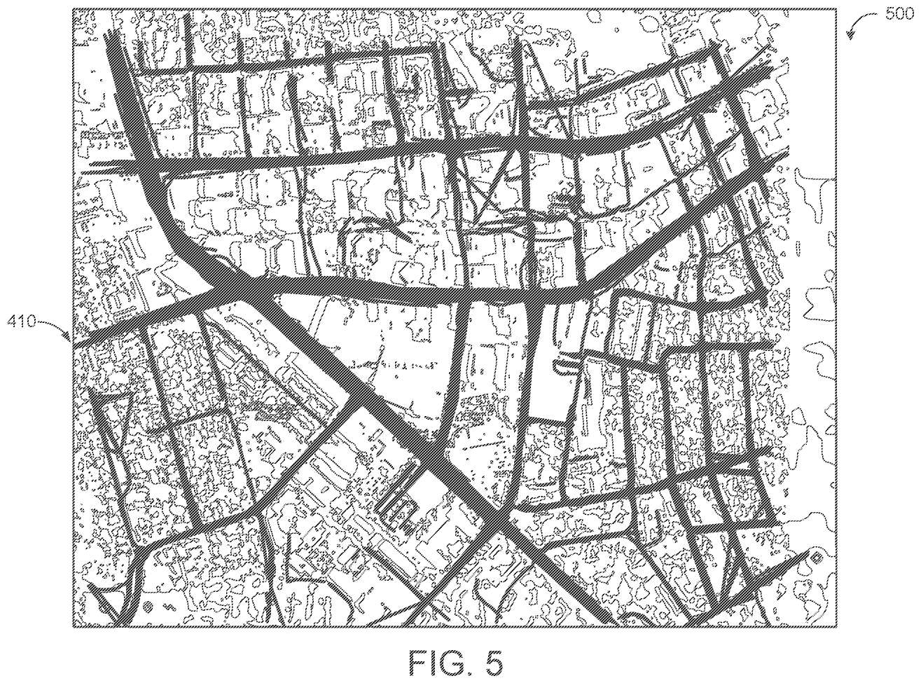

Referring now to the schematic view 400 of FIG. 4, In some examples, the loss controller 200 determines a respective relative path loss 410 between the corresponding second geographical point 210b and the corresponding third geographical point 210c using the first EM signal strength value 30a and the second EM signal strength value 30b. Optionally, the loss controller 200 determines the respective relative path loss 410 between the corresponding second geographical point 210b and the corresponding third geographical point 210c based on a difference between the EM signal strength values 30. In the example shown, the first EM signal strength value 30a (i.e., signal strength value) is equivalent to 11 dB above a set reference level at the mobile device 10 (at the second geographical location 210b) from the cellular base tower 220 (at the first geographical location 210a). The second EM signal strength value 30b (i.e., signal strength value) is equivalent to 10 dB above the same reference level at the mobile device 10 (at the third geographical location 210c) from the cellular base tower 220 (at the first geographical location 210a). In this scenario, the relative path loss 410, 410a is equivalent to 1 dB (i.e., 11 dB minus 10 dB). That is, there is a difference of 1 dB in the EM loss between the second geographical point 210b and the third geographical point 210c (when in communication with a device at the first geographical point 210a)

The schematic view 400 also includes a third EM signal strength value 30c corresponding to the EM loss at a fourth geographical location 210d. The fourth geographical location 210d is within the building 310b and hence the third EM signal strength value 30c is equivalent to a 20 dB loss. Thus, the relative loss 410b between the second EM signal strength value 30b and the third EM signal strength value 30c is equivalent to 10 dB. In this manner, the loss controller 200 may determine the relative EM loss between a series or sequence of EM signal strength values 30. Each EM signal strength value 30 may be associated with a specific geographical point 210 (i.e., determined via geolocation services of the mobile device 10). Each EM signal strength values 30 may be associated with other data as well. In some examples, the EM signal strength values 30 include a timestamp indicating a point in time that the EM signal strength value 30 was determined. The EM signal strength value 30 may also include a reference or identifier of the mobile device 10 or the emitter device (e.g., the cellular base tower 220) that the mobile device 10 was communicating with when the EM signal strength value 30 was determined. For example, the mobile device 10, at regular intervals (e.g., once per second, once per minute, etc.) determines the current EM signal strength value 30 for the current geographical location 210 at the current time with the current base tower 220 The mobile device 10 may determine a new EM signal strength value 30 when a threshold period of time has elapsed and/or when the mobile device 10 has traveled a threshold distance and/or when the EM loss has changed a threshold amount from the last measurement.

In some examples, the loss controller 200 determines the relative path loss 410 between multiple geographical locations 210. With continued reference to the example of FIG. 4, the loss controller 200, in some implementations, determines the relative loss between the first EM signal strength value 30a and the third EM signal strength value 30c using the relative path loss 410a and the relative loss 410b.

The relative path loss 410 provides a mechanism to extract “trusted” incremental path loss measurements from a series of measurements (e.g., the EM signal strength values 30) associated with the same or different geographical locations 210. Generally, the use of direct measurements of path loss (e.g., signal strength) cannot be trusted because there are a number of unknowns that make the measurement not directly usable. For example, the quality of the calibration of the receiver (e.g., the receiver with the mobile device 10) is typically unknown or impact of the mobile device's immediate placement is unknown (e.g., is the mobile device on the body of the user, in a package or briefcase, shielded by a body part, etc.). Moreover, emitter characteristics (i.e., the characteristics of the cellular base tower 220 or any other device communicating with the mobile device 10) are also often unknown (e.g., the power, the antenna, the location, etc.).

To overcome these unknowns, the loss controller 200 instead uses the relative path loss 410. The relative path loss is built upon a number of principles First, the free-space path loss (FSPL) component (i.e., the loss dependent upon the distance between the receiver and transmitter) of the total EM path loss is predictable when given rough knowledge of the emitter location. Moreover, in a dense, attenuative environment, the FSPL is much less significant that the attenuative media at reasonable ranges from the emitter. Second, the absolute value of signal level that is reported by a crowd-sourced device (e.g., the mobile devices 10) is not directly trustabie, but the relative differences in signal levels reported are sufficiently accurate to be trusted as a basis for propagation analysis. Third, attenuative effects are composable in that they accumulate across a path and can be isolated individually. Thus, these attenuative effects can be composed to create models of any path through a variety of media.

Thus, the loss controller 200, in some examples, determines the relative path loss 410 between two geographical points 210 by determining the difference in the EM signal strength value 30 (i.e., the signal strength) between the two geographical points 210. In some implementations, the loss controller 200 also subtracts the difference of an estimated FSPL between the two geographical points 210. The difference in the EM signal strength values 30 is highly likely to be independent of the analog calibration of the receiver of the mobile device 10, as these settings are likely to be identical between the two collected EM signal strength values 30 and will be driven by a digital detector for which increments in signal likely will be more accurately evaluated in the modem than in the signal chain (e.g., antenna, filters, amplifier, etc.).

The change in the FSPL between the two geographical points 210 may be estimated as long as the distance to the source of the signal (e.g., the cellular base tower 220) is known, can be estimated, or can be imputed. In most urban and indoor scenarios, the value of the change in FSPL is insignificant, as small changes in range have minimal impact on the FSPL compared to the losses caused by the attenuative environment. For example, the additional FSPL of 10 meters between a 100 meter range and a 200 meter range is 0.7 dB while the intervening attenuative material is likely to be tens of dB of loss or more in a typical building interior.

Put another way, when the loss controller 200 obtains a pair of EM signal strength values 30 from a mobile device 10, in some implementations, the loss controller 200 estimates a first free space component of the EM loss between the first geographical point 210 (i.e., the emitter's location) and the second geographical point 210 (i.e., the location of the mobile device 10 for the first EM signal strength value 30) and determines a first non-free space component of the EM loss between the first geographical point 210 and the second geographical point 210 using the estimated first free space component. For example, the loss controller 200 determines a difference between the first non-free space component and the second non-free space component. The loss controller 200 may also estimate a second free-space component of the EM loss between the first geographical point 210 and the third geographical point 210 (i.e., the location of the mobile device 10 for the second EM signal strength value 30) and determine a second non-free space component of the EM loss between the first geographical point 210 and the third geographical point 210 using the estimated second free space component. In some implementations, the loss controller 200 determines a difference between the first non-free space component and the third non-free space component. The loss controller 200 may determine the respective relative path loss 410 between she second geographical point 210 and the third geographical point 210 using the determined first non-free space component and the determined second non-ffee space component.

In some implementations, prior to determining the respective relative path loss 410 between corresponding geographical points 210, the loss controller 200 determines that both the first EM signal strength value 30 and the second EM signal strength value 30 each satisfy a minimum EM signal strength value. That is, in some examples, the loss controller 200 discards or otherwise does not process EM signal strength values 30 representative of atypicaily high signal strength as this may indicate proximity to the emitter source Locations near the emitter source (e.g, near the cellular base tower 220) may have more significant FSPL differences That is, the FSPL may be a more significant portion of the overall EM loss. It is understood that this is not inherently a two dimensional process. For example, a mobile device 10 traveling in the vertical dimension is an important aspect of modeling, as it provides floor-to-fioor path loss, which is itself highly useful and often critical in network and interference planning. That is, optionally, the first geographical point 210 of a pair of EM signal strength values 30 is on a first floor of a building and the second geographical point 210 of the pair of EM signal strength values is on a second floor of the same building.

Referring back to FIG. 1, after determining the relative path loss 410 for multiple EM signal strength values 30 for each of multiple mobile devices 10, the loss controller 200 generates, using the relative path loss 410 determined for each mobile device 10, aft EM propagation model 500 for a geographical area that encompasses the geographical points 210 associated with the EM signal strength values 30. That is, the result of generation of many relative path loss intervals enables the loss controller 200 to build a model of the losses that are present beyond the FSPL. The EM propagation model 500, in some examples, includes a set of three-dimensional, directional lines (i.e., loss lines) associated with a positive or negative value of path loss. In some examples, the loss lines are denoted with the endpoints sequenced to yield a positive signal strength value along the line. In spatial regions that are not obstructed, these loss values will be very low. When attentive structures are intersected, the loss values of lines crossing the obstruction will be correspondingly higher.

In some implementations, the EM signal strength values 30 include or represent a signal strength value. For example, the signal strength value represents a signal strength of a mobile device 10 in communication with a cellular base tower 220. In some scenarios, the actual signal strength is not measured by the reporting receiver (i.e., the mobile device 10), but another, metric (e.g., a higher-level metric) may be used to imply the signal strength. This could be any metric dependent on the specific signal value, such as coding rate, modulation type and order, error rate, or other internal metrics that relate directly to the received signal level.

The relative path loss 410 (i.e., the path loss pairs or loss lines) need not be determined on a sequential basis. In some implementations, the loss lines represent convolutions of experience (pairing the possible tuples of a longer set of reports) with the same emitter (e.g., cellular base tower 220) to create a more robust set of loss lines than the consecutive pairs would otherwise provide.

Referring now to FIG. 5, an exemplary EM propagation model 500 illustrates many relative path loss lines 410 for a geographical area. Here, the geographical area is an urban area and each pair of EM signal strength values 30 form “loss lines” (i.e., a line segment that connects the geographical location associated with each of the EM signal strength values 30). The relative path loss lines 410 of the exemplary model 500 of FIG. 5 primarily track streets throughout the area. However, given sufficient EM signal strength values 30, interiors of buildings may also be mapped. The loss controller 200 may generate the model 500 based on loss lines determined from EM signal strength values 30 gathered from one or more mobile devices 10. For example, multiple mobile devices 10 provide pairs of EM signal strength values 30 that are each associated with different geographical points 210. The model 500 may be built upon data received from multiple mobile devices 10 in communication with the same emitter For example, multiple mobile devices 10 communicate with the same cellular base tower 220 and each mobile device 10 tracks its respective EM signal strength values 30 from communications with the cellular base tower 220 with respect to the location of the respective mobile device 10.

In some implementations, the loss controller 200 determines an absolute path loss in lieu of or in addition to the relative path loss 410. For example, when accurate information regarding the emitter is a vail able and technical trust of the measurements of the receiver (e.g., the mobile device 10) is possible, the loss controller 200 instead relies on the absolute path loss reported by the mobile device 10. For instance, the Citizens Broadband radio Service (FCC Part 96) requires all emitters to report their location, power characteristics, and antenna characteristics. In other cases, free space measurements may be available to calibrate the emitter power using one device, which can then be used to create actual path loss measurements from that device or another device. The loss controller 200 may generate loss lines from the actual path loss identically to those of the loss lines of the relative path loss 410. The free-space loss term may be determined as exactly as possible within the location reporting accuracy of the emitter and reporting receivers. Thus, in these examples, the actual path loss can create a complete set of loss lines from emitter to reporting receiver in contrast to the loss lines of the relative path loss 410, which creates path loss lines only between the reporting points (i.e., geographical locations 210).

In some implementations, the loss controller 200 includes transient artifact removal (TAR) capabilities. The TAR capabilities account for scenarios where the mobile device 10 is not be positioned consistently across EM signal strength value 30 measurements. For example, a user 12 holds the mobile device 10 in a hand, up to an ear, etc., which may have a drastic impact on the measurements. As another example, there are blockages due to transient effects such as vehicles or bodies, elevator and metal doors, fading and similar effects that introduce additional path loss for one or more EM signal strength values 30. These impacts may distort the results to either higher or lower loss determinations that the loss controller 200 would otherwise determine in absence of the transient event. For example, ignoring reflective effects, the propagation artifact impact may cause a lower level of signal being recorded.

There are three possibilities for any one transient event. More than one transient event may be present for any pair of EM signal strength values 30 (i.e., loss lines). First, the transient event may be present for the “start” point of the loss line only (for relative path loss only). Second, the transient event may be present for the “end” point of the loss line only for both actual path loss and relative path loss. Third, the transient event may be present for both the “start” and “end” point of the loss line for relative path loss only. This third case can be safely ignored, as it applies to relative path loss only and would not impact the relative signal strength difference between the measurements. In the other two cases, the altenuative transient events will have the same effect of reducing measured signal strength at the reporting receiver. Therefore, the loss controller 200, in some examples, determines that the highest value of signal is most likely to be the normative value, and that it is likely to be the highest modal value of the distribution of received signal strength (i.e, most frequently occurring). This provides a fiter to examine loss pairs of EM signal strength values 30 to avoid pairs in which only one of the endpoints (i.e., EM signal strength values 30) was impacted by a given transient event.

For example, the loss controller 200 obtains several EM signal strength values 30 for a given mobile device 10 from relatively close to the same geographical location 210. For instance, the mobile device 10 is relatively stationary for a period of time, and thus the loss controller 200 obtains several EM signal strength values 30 associated with the same or nearly the same geographical location 210. In this scenario, the loss controller 200 may determine that one or more of the EM signal strength values 30 are atypicalSy low (e.g., lower than one or more other EM signal strength values 30 by a threshold amount) which may be the result of a transient event. Here, the loss controller may discard the atypically low EM signal strength value 30.

Because of the nature of the collateral (i.e., crowd-sourced) collection, it is not likely that there will be perfect alignment of the EM signal strength values 30. Thus, in some implementations, the loss controller 200 performs post processing to impute or determine the values of either known (through geospatial data) or unknown (such as unmapped building interiors) loss lines. Values of loss that are particularly valuable, such as the interior to exterior loss of buildings, the floor-to-floor loss of buildings, and a building's total loss end-to-end (e.g., for use in computing exterior paths that transverse the building) are extractable from the EM propagation model 500 formed by the loss lines by a number of known statistical or machine learning techniques. The loss controller 200 may determine path ioss from any geographical point to any other geographical point by analyzing possible networks that connect the proximity of each point to the proximity of the next point, and adding the loss values (i.e., in logarithmic representation). The endpoints of this analysis may be internal to a structure, and the loss controller 200 examines the internal loss between these points external to a structure, in which case the loss controller determines the total building attenuation, or both internal and external, in which case the loss controller 200 determines the inside/out path loss.

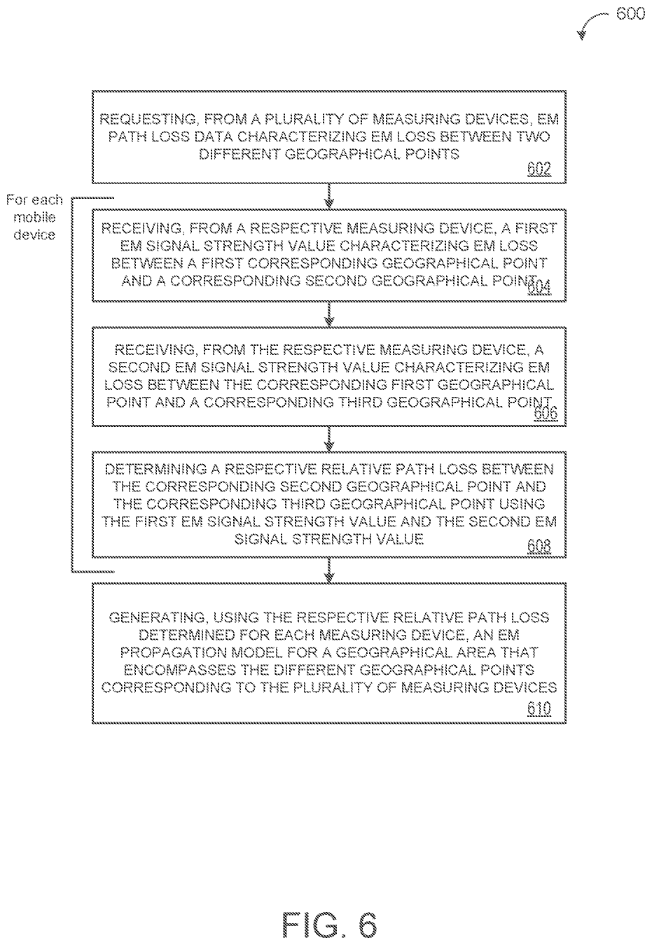

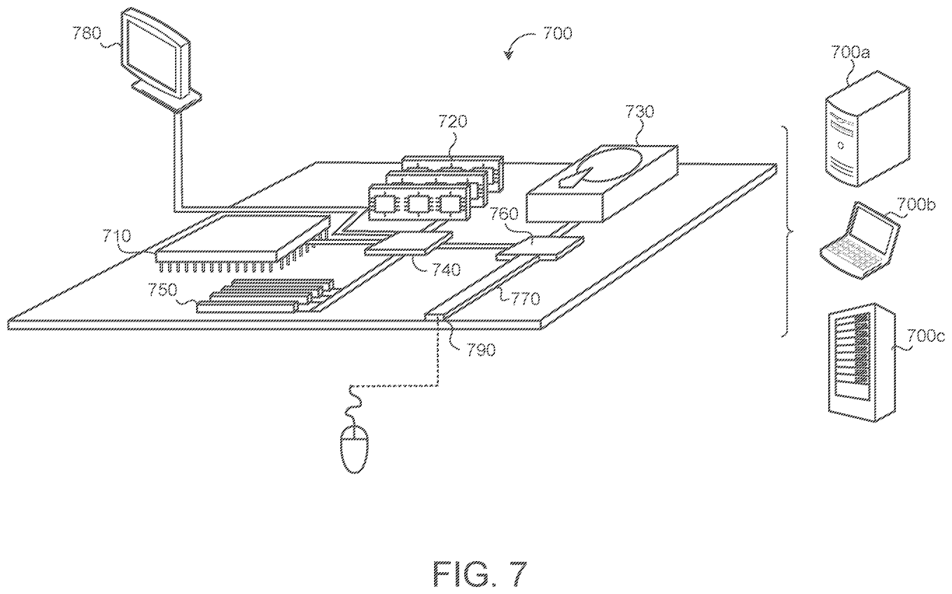

FIG. 6 is a flowchart of an exemplary arrangement of operations for a method 600 for electromagnetic propagation modeling calibration through crowd-sourced and secondary measurements. The method 600, at step 602, includes requesting, from a plurality of mobile devices 10, electromagnetic (EM) path loss data 30 characterizing EM loss between two different geographical points 210. At operation 604, the method 600 includes, for each respective mobile device 10 in the plurality of mobile devices 10, receiving, from the respective mobile device 10, a first EM signal strength value 30 characterizing EM loss between a corresponding first geographical point 210 and a corresponding second geographical point 210. The corresponding first and second geographical points 210 corresponding to the respective mobile device 10 are different than the corresponding first and second geographical points 210 corresponding to each other mobile device 10 in the plurality of mobile devices 10. At operation 606, the method 600 includes receiving, from the respective mobile device 10, a second EM signal strength value 30 characterizing EM loss between the corresponding first geographical point 210 and a corresponding third geographical point 210. The corresponding third geographical point 210 corresponding to the respective mobile device 10 is different than the corresponding third geographical point 210 corresponding to each other mobile device 10 in the plurality of mobile devices 10.

At operation 608, the method 600 includes determining a respective relative path loss 410 between the corresponding second geographical point 210 and the corresponding third geographical point 210 using the first EM signal strength value 30 and the second EM signal strength value 30. The method 600, at operation 610, includes generating, using the respective relative path loss 410 determined for each mobile device 10 of the plurality of mobile devices 30, an EM propagation model 500 for a geographical area that encompasses the different first and second geographical points 210 corresponding to the plurality of mobile devices 10.

FIG. 7 is schematic view of an example computing device 700 that may be used to implement the systems and methods described in this document The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730. 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system)

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPRQM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as pan of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program. ” Example applications include, but are not limited to, system diagnostic applications, system management applications, system maintenance applications, word processing applications, spreadsheet applications, messaging applications, media streaming applications, social networking applications, and gaining applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., art FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory , media and memory devices, including by way of example semiconductor memory devices, e.g., EPROM, EEPROM, and flash memory devices; magnetic disks, e.g , internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example; by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
requesting, from a plurality of mobile devices, electromagnetic (EM) path loss data characterizing EM loss between two different geographical points;
for each respective mobile device in the plurality of mobile devices:
receiving, from the respective mobile device, a first EM signal strength value characterizing EM loss between a corresponding first geographical point and a corresponding second geographical point, the corresponding first and second geographical points corresponding to the respective mobile device are different than the corresponding first and second geographical points corresponding to each other mobile device in the plurality of mobile devices,
receiving, from the respective mobile device, a second EM signal strength value characterizing EM loss between the corresponding first geographical point and a corresponding third geographical point, the corresponding third geographical point corresponding to the respective mobile device is different than the corresponding third geographical point corresponding to each other mobile device in the plurality of mobile devices; and
determining, for the respective mobile device, a respective relative path loss between the corresponding second geographical point and the corresponding third geographical point using the first EM signal strength value and the second EM signal strength value; and
generating, using the respective relative path loss determined for each mobile device of the plurality of mobile devices, an EM propagation model for a geographical area that encompasses the different first and second geographical points corresponding to the plurality of mobile devices.

2. The method of claim 1, wherein determining the respective relative path loss between the corresponding second geographical point and the corresponding third geographical point comprises:
estimating a first free space component of the EM loss between the corresponding first geographical point and the corresponding second geographical point;
determining a first non-free space component of the EM loss between the corresponding first geographical point and the corresponding second geographical point using the estimated first free space component;
estimating a second free space component of the EM loss between the corresponding first geographical point and the corresponding third geographical point;
determining a second non-free space component of the EM loss between the corresponding first geographical point and the corresponding third geographical point using the estimated second free space component, and
determining the respective relative path loss between the corresponding second geographical point and the corresponding third geographical point using the determined first non-free space component and the determined second non-free space component.

3. The method of claim 2, wherein determining the respective relative path loss between the corresponding second geographical point and the corresponding third geographical point is based on a difference between the first non-free space component and the second non-free space component.

4. The method of claim 1, wherein one or more of the plurality of mobile devices comprises a smart phone.

5. The method of claim 1, wherein the first EM signal strength value and the second EM signal strength value each represent a corresponding signal strength value level above a reference value.

6. The method of claim 5, wherein the first EM signal strength value indicates a strength of a signal received from a cellular base station.

7. The method of claim 1, wherein, for each respective mobile device in the plurality of mobile devices, tire operations further comprise:
receiving, from the respective mobile device, a third EM signal strength value characterizing EM loss between the corresponding first geographical point and the corresponding second geographical point, wherein the first EM signal strength value is greater than the third EM signal strength value; and
discarding the third EM signal strength value

8. The method of claim 1, wherein, for each respective mobile device in the plurality of mobile devices, the operations further comprise, prior to determining the respective relative path loss between the corresponding second geographical point and the corresponding third geographical point, determining that both the first EM signal strength value and the second EM signal strength value satisfy a minimum EM signal strength value.

9. The method of claim 1, wherein, for one of the respective mobile devices of the plurality of mobile devices:
the corresponding first geographical point comprises a location within a first floor of a building; and
the corresponding second geographical point comprises a location within a second floor of the building.

10. The method of claim 1, wherein, for each respective mobile device in the plurality of mobile devices, the operations further comprise:
receiving, from the respective mobile device, a third EM signal strength value characterizing EM loss between the corresponding first geographical point and a corresponding fourth geographical point; and
determining a relative path loss between the corresponding third geographical point and the corresponding fourth geographical point using the second EM signal strength value and the third EM signal strength value

11. The method of claim 10, wherein, for each respective mobile device in the plurality of mobile devices, the operations further comprise, determining a relative path loss between the second geographical point and the corresponding fourth geographical point using the relative path loss between the second geographical point and the corresponding third geographical point and the relative ioss path between the corresponding third geographical point and the corresponding fourth geographical point.

12. A system comprising:
data processing hardware; and
memory hardware in communication with the data processing hardware, the memory hardware storing instructions that when executed on the data processing hardware cause the data processing hardware to perform operations comprising:
requesting, from a plurality of mobile devices, electromagnetic (EM) path loss data characterizing EM loss between two different geographical points;
for each respective mobile device in the plurality of mobile devices;
receiving, from the respective mobile device, a first EM signal strength value characterizing EM loss between a corresponding first geographical point and a corresponding second geographical point, the corresponding first and second geographical points corresponding to the respective mobile device are different than the corresponding first and second geographical points corresponding to each other mobile device in the plurality of mobile devices;
receiving, from the respective mobile device, a second EM signal strength value characterizing EM loss between the corresponding first geographical point and a corresponding third geographical point, the corresponding third geographical point corresponding to the respective mobile device is different than the corresponding third geographical point corresponding to each other mobile device in the plurality of mobile devices; and
determining, for the respective mobile device, a respective relative path loss between the corresponding second geographical point and the corresponding third geographical point using the first EM signal strength value and the second EM signal strength value; and
generating, using the respective relative path loss determined for each mobile device of the plurality of mobile devices, an EM propagation model for a geographical area that encompasses the different first and second geographical points corresponding to the plurality of mobile devices.

13. The system of claim 12, wherein determining the respective relative path loss between the corresponding second geographical point and the corresponding third geographical point comprises:
estimating a first free space component of the EM loss between the corresponding first geographical point and the corresponding second geographical point;
determining a first non-tree space component of the EM loss between the corresponding first geographical point and the corresponding second geographical point using the estimated first free space component;
estimating a second free space component of the EM loss between the corresponding first geographical point and the corresponding third geographical point;
determining a second non-free space component of the EM loss between the corresponding first geographical point and the corresponding third geographical point using the estimated second free space component; and
determining the respective relative path loss between the corresponding second geographical point and the corresponding third geographical point using the determined first non-free space component and the determined second non-free space component.

14. The system of claim 13, wherein determining the respective relative path loss between the corresponding second geographical point and the corresponding third geographical point is based on a difference between the first non-free space component and the second non-free space component.

15. The system of claim 12, wherein one or more of the plurality of mobile devices comprises a smart phone.

16. The system of claim 12, wherein the first EM signal strength value and the second EM signal strength value each represent a corresponding signal strength value level above a reference value.

17. The system of claim 16, wherein the first EM signal strength value indicates a strength of a signal received from a cellular base station.

18. The system of claim 12, wherein, for each respective mobile device in the plurality of mobile devices, the operations further comprise:
receiving, from the respective mobile device, a third EM signal strength value characterizing EM loss between the corresponding first geographical point and the corresponding second geographical point, wherein the first EM signal strength value is greater than the third EM signal strength value; and
discarding the third EM signal strength value.

19. The system of claim 12, wherein, for each respective mobile device in the plurality of mobile devices, the operations further comprise, prior to determining the respective relative path loss between the corresponding second geographical point and the corresponding third geographical point, determining that both the first EM signal strength value and the second EM signal strength value satisfy a minimum EM signal strength value.

20. The system of claim 12, wherein, for one of the respective mobile devices of the plurality of mobile devices:
the corresponding first geographical point comprises a location within a first floor of a building; and
the corresponding second geographical point comprises a location within a second floor of the building.

21. The system of claim 12, wherein, for each respective mobile device in the plurality of mobile devices, the operations further comprise:
receiving, from the respective mobile device, a third EM signal strength value characterizing EM loss between the corresponding first geographical point and a corresponding fourth geographical point; and
determining a relative path loss between the corresponding third geographical point and the corresponding fourth geographical point using the second EM signal strength value and the third EM signal strength value.

22. The system of claim 21, wherein, for each respective mobile device in the plurality of mobile devices, the operations further comprise, determining a relative path loss between the second geographical point and the corresponding fourth geographical point using the relative path loss between the second geographical point and the corresponding third geographical point and the relative loss path between the corresponding third geographical point and the corresponding fourth geographical point.
